(19) United States
(12) Patent Application Publication
(10) Pub. No.: US 2007/0114101 A1
(43) Pub. Date: May 24, 2007

(54) Disc brake assembly with parking brake mechanism

(75) Inventor: David Elderfield, Canterbury (GB)

Correspondence Address: JACKSON, DEMARCO, TIDUS & PACKENPAUGH, 2815 TOWNSGATE ROAD, SUITE 200, WESTLAKE VILLAGE, CA, 91361-3010, US

(73) Assignee: RALLY DESIGN, LTD.

(21) Appl. No.: 11/603,499

(22) Filed: Nov. 21, 2006

(30) Foreign Application Priority Data
Nov. 24, 2005 (GB) 0523897.7

(51) Int. Cl. F16D 55/26

(52) U.S. Cl. 188/72.6

(57) ABSTRACT

A disc brake having a parking brake mechanism and in particular a parking brake mechanism which is integrally incorporated into the disc brake assembly.

### PRIORITY CLAIM

This application claims the benefit of Request For Grant Of A Patent No. 0523897.7 entitled DISC BRAKE ASSEMBLY WITH PARKING BRAKE MECHANISM filed Nov. 24, 2005 in the United Kingdom.

### FIELD OF INVENTION

The present invention relates to a disc brake having a parking brake mechanism and in particular to a parking brake mechanism which is integrally incorporated into the disc brake assembly.

### BACKGROUND OF THE INVENTION

Conventional disc brakes on the majority of road cars comprise a single piston caliper mounted in a cast iron housing. In the past, it has been necessary for the handbrake or parking brake to be a separate brake system mounted on the rear wheels because the leverage of the handbrake is limited and yet the parking brake is required to deliver a minimum of 20% of the performance of the footbrake, under UK law.

More recently, attempts have been made to integrate a parking brake mechanism into the disc brake assembly. An example of this can be found in U.S. 2005/02117949 which describes the use of a ball-ramp assembly to translate displacement of a handbrake lever into axial displacement of the piston of the disc, brake. FIG. 1 is taken from U.S. 2005/0217949 and shows a piston cavity 1 in which a piston 2 is slidably mounted. The piston cavity 2 is provided in a caliper body 3 (the brake pads are not illustrated). To the right of FIG. 1 gears 4a and 4b communicate a lever displacement (from the handbake 5) to a first ramp plate 6a. A second ramp plate 6b is aligned with the first ramp plate 6a with a bearing member 7 mounted therebetween. The facing surfaces of the two ramp plates 6a, 6b define between them a variable space traversed by the bearing member 7. The second ramp plate 6b is slidably mounted within a ball-ramp cavity 8 and is arranged so that axial movement of the second ramp plate 6b causes a spindle mechanism 9 mounted within the piston 2 to move axially thereby engaging the piston of the disc brake. When the handbrake lever 5 is lifted this produces a rotational displacement of the first ramp plate 6a which in turn causes the bearing member 7 to move which in turn urges the second ramp plate 6b axially away from the first ramp plate. This axial displacement of the second ramp plate 6b is communicated by means of the spindle mechanism 9 to the piston 2 thereby engaging and holding the disc brake until the handbrake lever 5 is released.

It will be immediately apparent that in the case of U.S. 2005/0217949, integration of the parking brake mechanism into the disc brake assembly has resulted in a complex mechanism with many parts and requiring accurate alignment not only of the piston within the piston cylinder but also the spacing of the two ramp plates and the positioning of the spindle within the piston body.

In so far as top of the range road cars and racing cars are concerned, these have adopted four piston caliper disc brake assemblies, often involving an aluminium casing, for which no integrated parking brake mechanism is available.

### SUMMARY OF THE INVENTION

The present invention seeks to address the problems identified above with respect to integrating a parking brake with disc brake assemblies and in particular the present invention seeks to provide an integrated disc brake and parking brake assembly which is suited for, but not limited to, use with multiple piston disc brakes.

The present invention therefore provides a disc brake assembly for a vehicle comprising a caliper body; at least one piston and cylinder arrangement provided in the caliper body; a pair of opposed friction pads; and an integral parking brake mechanism comprising at least one pair of levers mounted on the caliper body and arranged for engagement with the pair of friction pads, each lever being pivotable about a first end and having cable engaging means at an opposed second end; a cable member engaging with the second ends of the levers whereby displacement of the cable member causes at least one of said pair of levers to pivot and engage with a respective friction pad.

In a preferred embodiment, the parking brake mechanism further includes biasing means biasing at least one of the pair of levers towards a disengaged position. Said biasing means may comprise a torsional spring member provided on a lever axle.

Additionally, the cable member may include an eyelet provided at a free end of the cable and the second end of said one of the pair of levers includes a hook for engagement with the eyelet.

Ideally, each of the levers has a curved ramp surface for engagement with a respective friction pad, the curvature of the surface being selected to maintain a substantially axially directed force on the friction pad during pivoting movement of the lever.

In a preferred embodiment the disc brake assembly comprises four piston and cylinder arrangements provided in two opposed pairs and said pair of levers are positioned between said two pairs of piston and cylinder arrangements.

Thus, it may be seen that with the present invention a parking brake mechanism is integrated with a conventional disc brake assembly in a particularly simple and straightforward manner and in a manner which does not involve large numbers of additional components.

### BRIEF DESCRIPTION OF THE DRAWINGS

An embodiment of the present invention will now be described, by way of example only, with reference to the accompanying drawings, in which:

FIG. 1 is a sectional view of a known integrated single piston disc brake and parking brake mechanism;

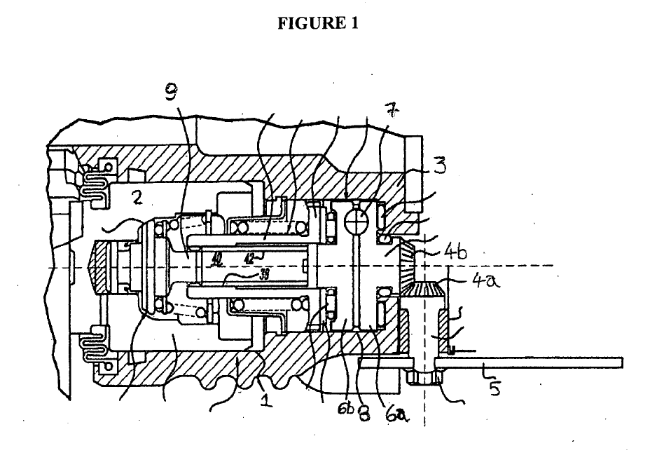

FIG. 2 is a sectional view through a four piston disc brake assembly with an integrated parking brake mechanism in accordance with the present invention;

FIG. 3 is an illustration of the parking brake mechanism of FIG. 2;

FIG. 4 is a first perspective view illustrating the parking brake mechanism mounted in the four piston disc brake assembly of FIG. 2; and

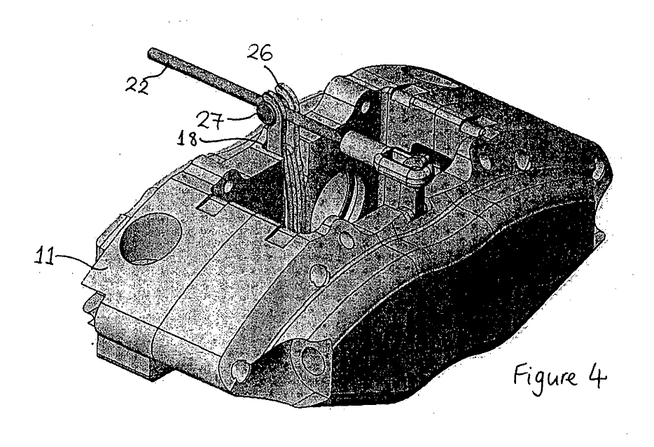

FIG. 5 is a second perspective view illustrating the parking brake mechanism and disc brake assembly of FIG. 4.

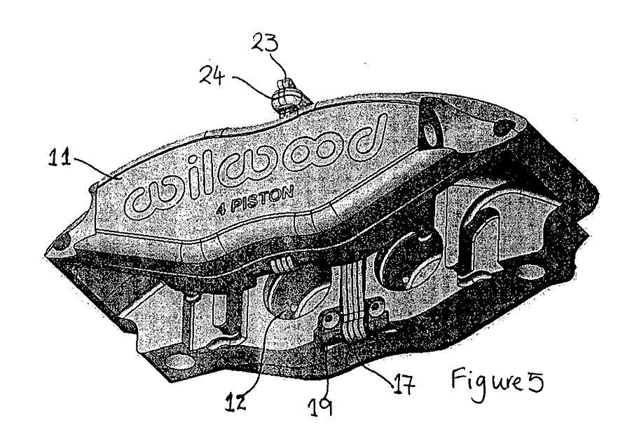

### DETAILED DESCRIPTION OF THE INVENTION

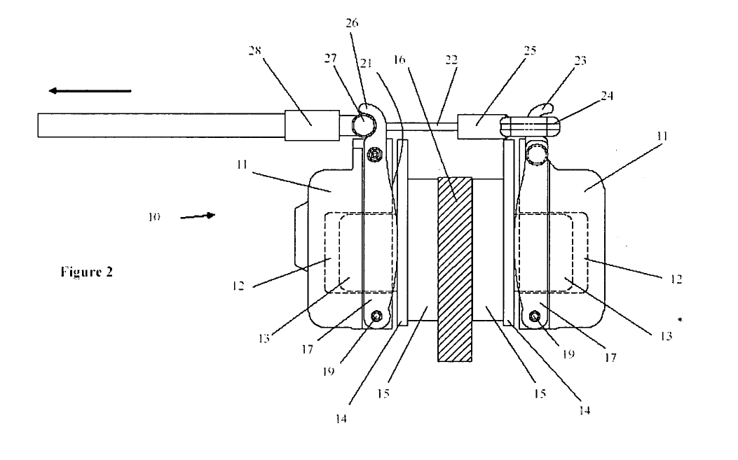

The disc brake assembly 10 of FIG. 2, which is adapted for use with road vehicles, generally comprises a caliper body 11 having opposed hydraulic chambers 12 within each of which are mounted pistons 13 for axial sliding movement within their respective hydraulic chamber. The disc brake assembly 10 is a four pot arrangement (two pistons either side mounted in a common caliper body) of which only two opposed pistons and their hydraulic chambers are visible in FIG. 2. The surface of each piston 13 which faces outwardly from its hydraulic chamber has a friction pad mounted thereon comprising a supporting backboard 14 and a friction liner 15. In use, the disc brake assembly 10 is mounted so that the friction liners 15 are positioned either side of and engage with the disc rotor 16 of the vehicle wheel. Although not illustrated, extending through the caliper body 11 are fluid channels in communication with respective hydraulic chambers 12. The fluid channels are in fluid communication with a common brake line so that when the vehicle footbrake (not illustrated) is depressed this is communicated as fluid pressure to each of the pistons 13 in their hydraulic chambers 12. The pistons, in turn, urge the friction pads 14, 15 towards each other so that they engage with the disc rotor 16 of the vehicle wheel. The features of the disc brake assembly described above are conventional in design such as may be found on the Billet Dynalite™ caliper of Wilwood Engineering.

The disc brake assembly 10 additionally includes an opposed pair of levers 17 that are mounted in open channels 18 provided between adjacent pistons 13 in each side of the caliper body 11. Each lever 17 is attached at a first end to the caliper body 11 by means of an axle 19 whereby the lever 17 is free to pivot about the axle 19. Each axle 19 is, in turn, mounted to the caliper body by means of a pair of cradles 20 which engage opposed ends of each axle 19. The levers 17 are biased by suitable means towards a disengaged position where they are aligned with their channels in the caliper body 11. A torsional spring (not illustrated) provided on each axle 19 is an example of a suitable biasing means. Each lever 17 has a ramp surface 21 which engages with the backboard 14 of a respective friction pad. The ramp surface 21 of the lever is shaped so as to remain substantially in point contact with the backboard 14 during pivoting movement of the lever about the axle 19 and so as to deliver an axial force substantially parallel to the pistons 13.

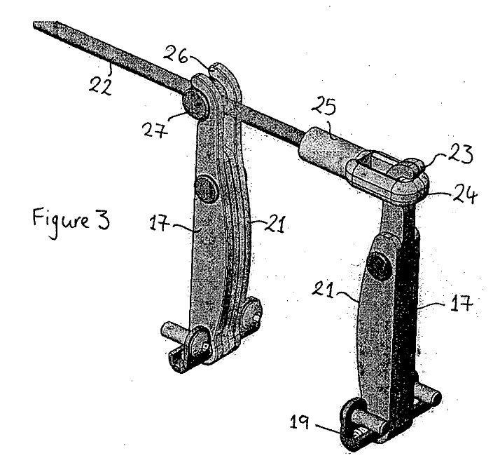

Each lever 17 also engages with a cable 22 which is, in turn, connected to the parking brake lever (not illustrated). A first one of the pair of levers 17 has a hook 23 at a second end of the lever which hook 23 freely engages with an eyelet 24 at the cable end 25 of the cable. The hook 23 faces away from the cable end 25 and projects through the eyelet 24. The second of the pair of levers 17 has a corresponding hook 26 which also faces away from the cable end 25. This hook 26 engages with a cable block 27 mounted on the cable 22 at a position along the length of the cable 22 which is adjustable by means of an adjuster 28 (not shown in FIG. 3).

In use, when the parking brake is activated, the cable 22 is pulled in a direction away from the disc brake assembly. This movement of the cable 22 causes the eyelet 24 to engage with the hook 23 of the first lever 17 and to pull the hook in the direction of the cable thereby causing the lever to pivot about its axle 19 out of its channel in the caliper body 11 to an engaging position. As a result of the pivoting action of the lever 17, the ramp surface 21 of the lever engages with the backboard 14 of the friction pad and urges the friction pad to engage with and hold the disc rotor 16. At the same time, the cable block 27 moves away from the disc brake assembly releasing the hook 26 of the second lever 17 which remains in position in its channel in the caliper body 11. When the parking brake is released, the cable moves back towards the disc brake assembly which releases the tension from the first lever 17 allowing it to return to its original position within its channel in the caliper body, by means of the biasing member. This in turn releases the friction pad 14, 15 from engagement with the disc rotor 16. In addition, when the parking brake is released, the cable block 27 returns to engage with the hook 26 of the second lever 17.

Thus it may be seen that the parking brake mechanism described above is integrated with a conventional disc brake assembly in a particularly simple and straightforward manner and in a manner which does not involve large numbers of additional components. Moreover, adjustment and alignment of the parking brake mechanism is easily achieved by means solely of the cable adjuster 28, the position of which dictates the separation of the hooks 23 and 26 and hence the contact of the ramp surfaces 21 of each lever 17 with the backboards 14 of the friction pads.

This parking brake mechanism may be applied to single pot disc brakes as well as multiple pot disc brakes. In the case of a single pot disc brake, ideally, each side of the disc rotor would be engaged by a pair of levers, arranged either side of the single piston, and having a common axle and a common hook provided centrally on a cross member for engagement with the cable so that a balanced force may be applied to the friction pad.

The integrated disc brake assembly and parking brake mechanism of the present invention is particularly suited for use with light-weight vehicles and is adapted for retro-fitting to existing vehicles having a conventional parking brake cable.

I claim:

1. A disc brake assembly for a vehicle comprising:
a caliper body;
at least one piston and cylinder arrangement provided in the caliper body;
a pair of opposed friction pads;
an integral parking brake mechanism comprising at least one pair of levers mounted on the caliper body and arranged for engagement with the pair of friction pads, each lever being pivotable about a first end and having cable engaging means at an opposed second end; and,
a cable member engaging with the second ends of the levers whereby displacement of the cable member causes at least one of said pair of levers to pivot and engage with a respective friction pad.

2. The disc brake assembly of claim 1, wherein the parking brake mechanism further includes biasing means biasing at least one of the pair of levers towards a disengaged position.

3. The disc brake assembly of claim 2, wherein said biasing means comprises a torsional spring member provided on a lever axle.

4. The disc brake assembly of claim 3, wherein the cable member includes an eyelet provided at a free end of the cable and the second end of said one of the pair of levers includes a hook for engagement with the eyelet.

5. The disc brake assembly of claim 4, wherein each of the levers has a curved ramp surface for engagement with a respective friction pad, the curvature of the surface being selected to maintain a substantially axially directed force on the friction pad during pivoting movement of the lever.

6. The disc brake assembly of claim 5, further comprising four piston and cylinder arrangements in two opposed pairs and said pair of levers are positioned between said two pairs of piston and cylinder arrangements.

7. The disc brake assembly of claim 6, further comprising a means for adjusting the separation of the pair of levers.
